(19) United States
(12) Patent Application Publication
(10) Pub. No.: US 2024/0270018 A1
(43) Pub. Date: Aug. 15, 2024

(54) SYSTEMS AND METHODS FOR WHEEL DISCONNECT

(71) Applicant: Dana Automotive Systems Group, LLC, Maumee, OH (US)

(72) Inventor: Anthony PESCARA, Oregon, OH (US)

(21) Appl. No.: 18/299,422

(22) Filed: Apr. 12, 2023

Related U.S. Application Data
(60) Provisional application No. 63/484,974, filed on Feb. 14, 2023.

(51) Int. Cl. B60B 27/00; B60B 27/02; B60B 27/06; B60K 17/04

(52) U.S. Cl. CPC B60B 27/0047; B60B 27/0015; B60B 27/02; B60B 27/065; B60K 17/043

(57) ABSTRACT

Systems are provided for a disconnect system for an electric vehicle. In one example, a system includes a disconnect device of an axle system, the disconnect device comprising a clip configured to engage with a first groove of an axle and a second groove of a side gear.

### TECHNICAL FIELD

The present description relates generally to a wheel disconnect system for a vehicle.

### BACKGROUND AND SUMMARY

Electric vehicles may include a drivetrain that couples a motor and gear system to wheels of the vehicle. In some conditions, it may be desired to disconnect the wheels from the drivetrain so that they may spin independently of the motor and gear system. One such example may include when the vehicle is being towed. Current solutions may not provide a simple method for disconnecting the wheels from the drivetrain to bypass a parking mechanism.

In one example, the issues described above may be at least partially solved by a system including a disconnect device of an axle system, the disconnect device comprising a clip configured to engage with an axle groove of an axle and a side gear groove of a side gear.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain, according to an embodiment of the present disclosure;

FIGS. 2A and 2B are a first embodiment of a disconnect system, according to an embodiment of the present disclosure;

FIGS. 3A and 3B are a second embodiment of a disconnect system, according to an embodiment of the present disclosure;

FIGS. 4A and 4B are a third embodiment of a disconnect system, according to an embodiment of the present disclosure; and

FIG. 5 is a method for operating the disconnect system, according to an embodiment of the present disclosure.

### DETAILED DESCRIPTION

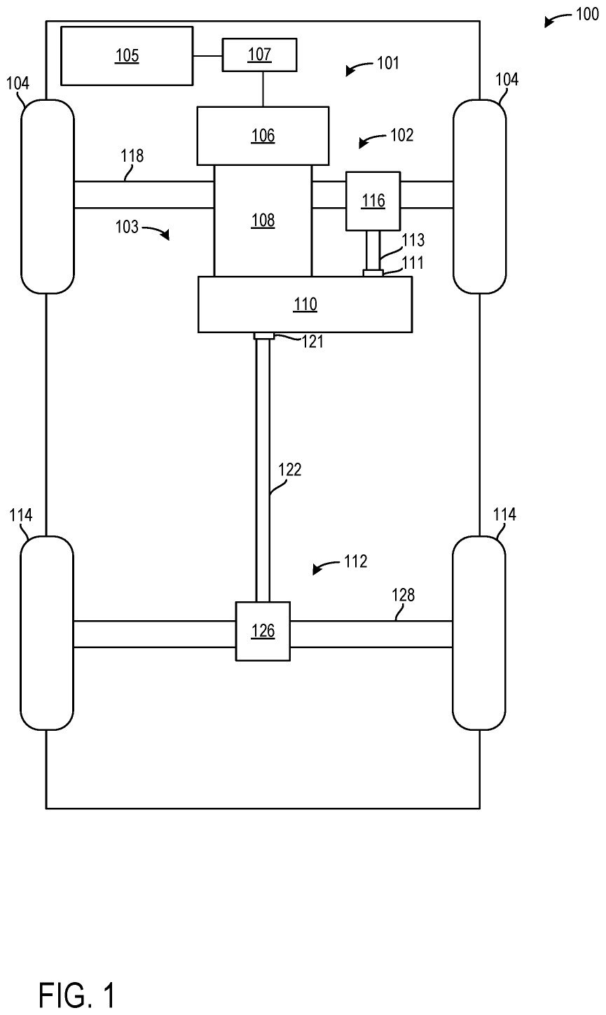

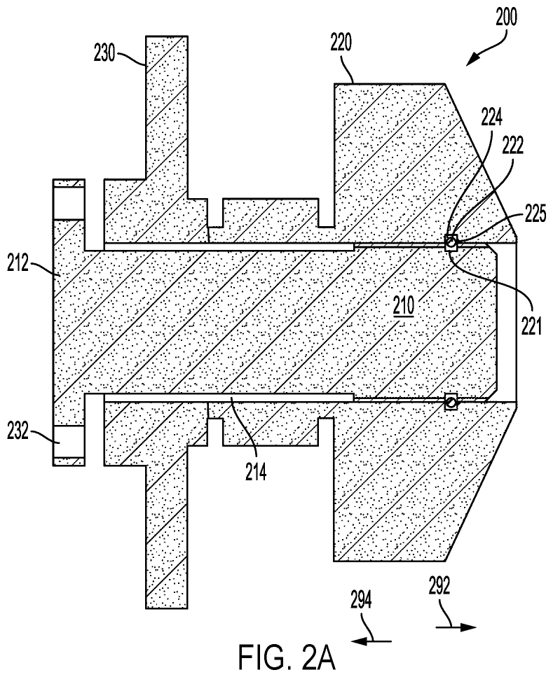

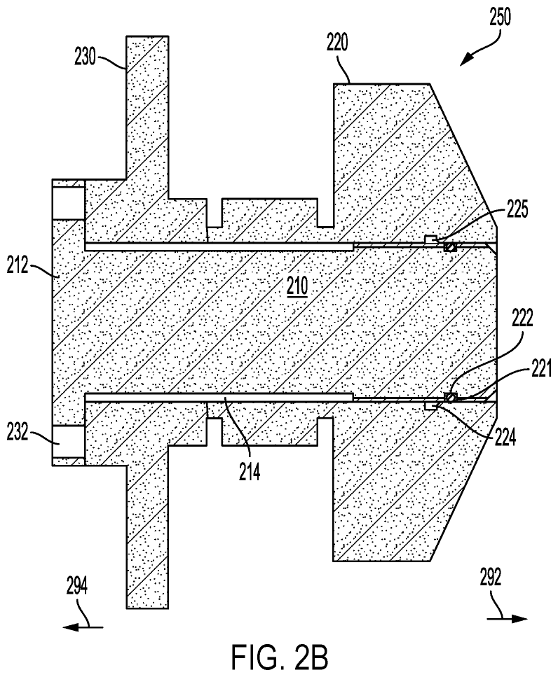

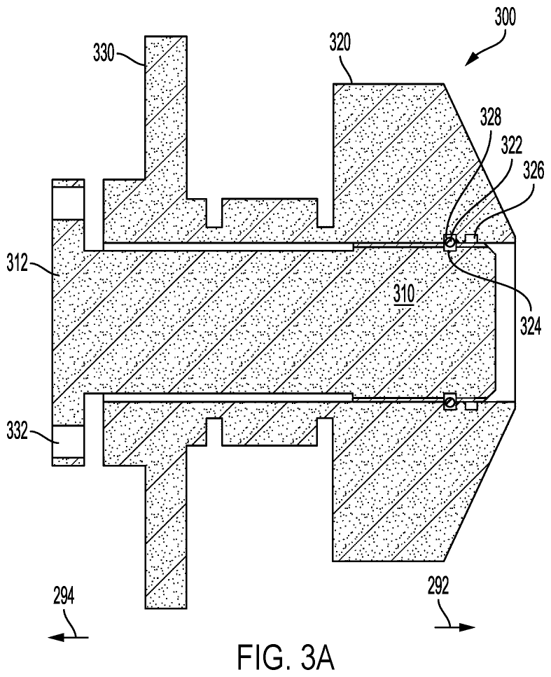

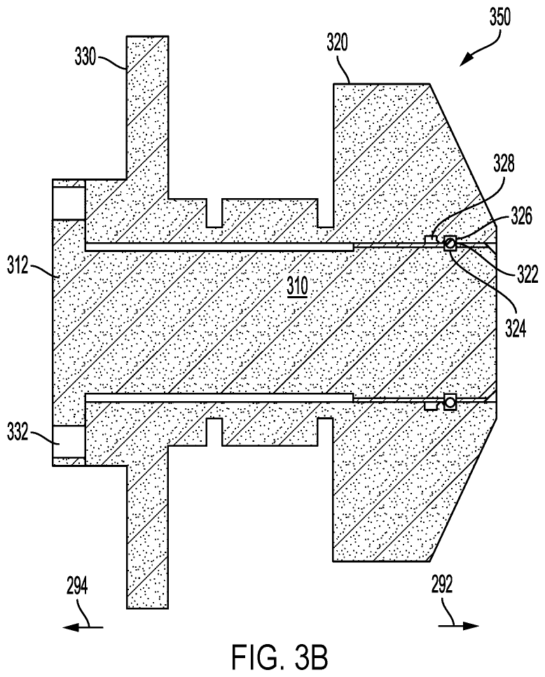

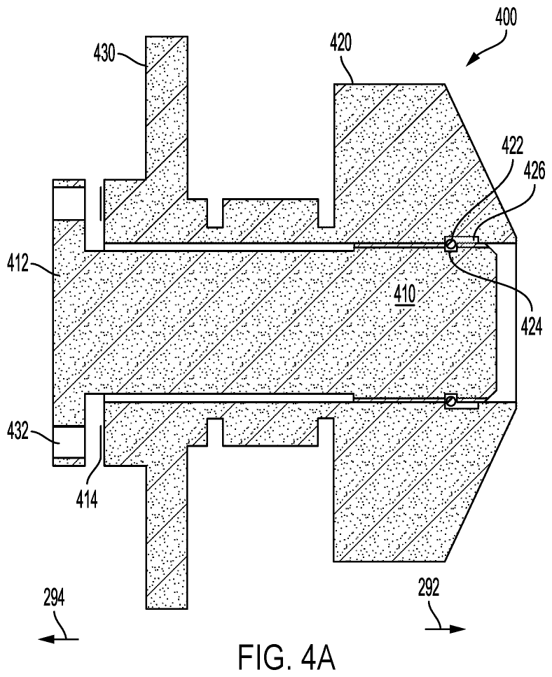

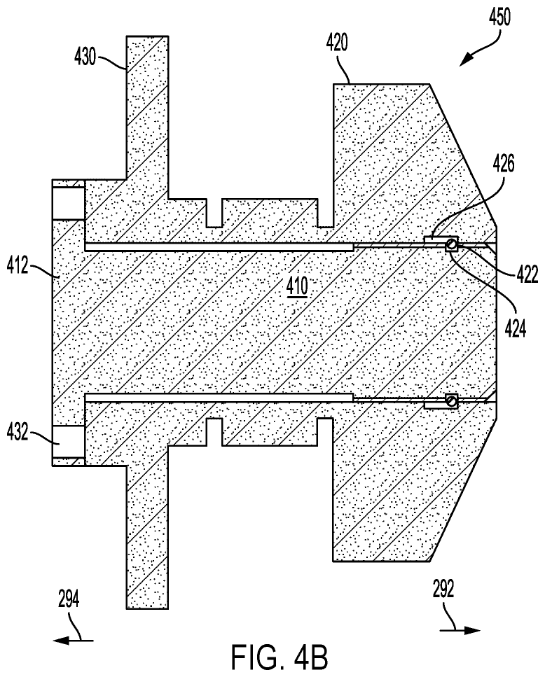

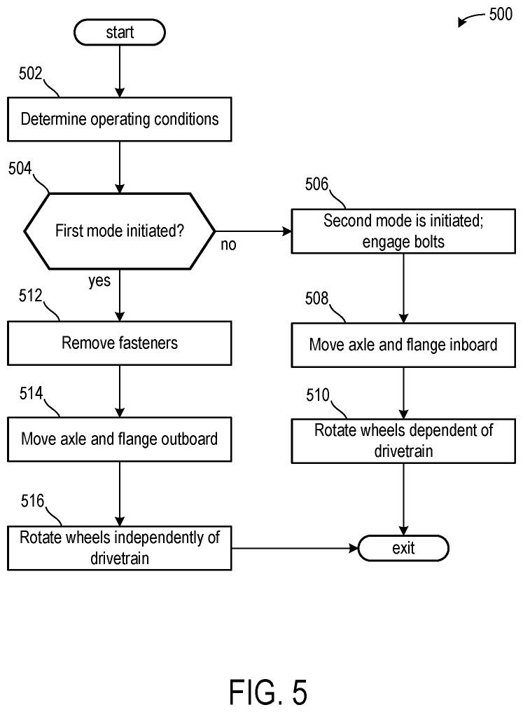

The following description relates to a system for a disconnect system of a vehicle. In one example, the vehicle comprises an electric drive unit comprising an inverter, electric motor, gearbox, and the like, as shown in FIG. 1. FIGS. 2A and 2B are a first embodiment of a disconnect system, according to an embodiment of the present disclosure. FIGS. 3A and 3B are a second embodiment of a disconnect system, according to an embodiment of the present disclosure. FIGS. 4A and 4B are a third embodiment of a disconnect system, according to an embodiment of the present disclosure. FIG. 5 is a method for operating the disconnect system, according to an embodiment of the present disclosure.

In one example, the disclosure provides support for a disconnect system to disengage the axle shaft bolts to disconnect the system from a drivetrain. By disengaging the axle shaft bolts, the wheel hubs are allowed to spin independently from the axle shafts and the rest of the gear train. The shafts may be too large to fully remove and doing so will allow lubricant to escape and contamination to enter the system. Additionally, for a vehicle operator attempting to operate the disconnect system, there may be insufficient space on a roadside to remove an entire axle. The disconnect system may use a snap ring and a series of grooves to both retain the axle shaft in the assembly while maintaining the sealing system for the lubricant as well as securing an air gap to eliminate contact between the stationary axle shaft and free spinning full float hub. Once the bolts are disengaged the axle shaft can be pulled outward until the snap ring is engaged into the groove to positively locate and avoid contact with the hub. One method is to use one groove in the shaft and one in the side gear. In the installed condition, which includes the wheel hub spinning dependently with the axle, the clip is compressed and inboard of the side gear groove. Once the bolts are disengaged and in an uninstalled condition, the shaft can be pulled outboard until the clip snaps into the groove. Another embodiment may include two grooves in the side gear, one groove in the axle shaft and one snap ring. The clip may expand in both the installed condition as well as the towing condition (e.g., uninstalled condition) in its respective grooves eliminating stress on the snap ring in constant compression. As such, a longevity of the system may be increased. An additional system is to use an oversized width groove in the side gear, a groove in the shaft and one snap ring that allows the shaft to float outboard and a spring or other method would apply pressure pushing the shaft outboard avoiding contact with the hub.

FIGS. 1-4B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2A-4B are shown approximately to scale, however, other dimensions may be used if desired.

Turning now to FIG. 1, a vehicle 100 is shown comprising a powertrain 101 and a drivetrain 103. The powertrain comprises a prime mover 106 and a transmission 108. The prime mover 106 may be an internal combustion engine or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC).

The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications. In one example, the vehicle 100 is an electric vehicle.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Turning now to FIGS. 2A and 2B, they show a first embodiment of an axle shaft 210 and wheel in a first mode 200 and a second mode 250, respectively. FIGS. 2A and 2B are described in tandem herein. The axle shaft 210 is coupled to a side gear 220 and a wheel hub 230. The side gear 220 may be more central (e.g., inboard) than the wheel hub 230. In one example, the first mode 200 is a tow mode and the second mode 250 is a drive mode. In one example, the axle shaft 210 is identical to a shaft of the first set of axle shafts 118 and/or a shaft of the second set of axle shaft 128.

In the embodiment of FIGS. 2A and 2B, arrow 292 illustrates an inboard direction and arrow 294 illustrates an outboard direction. The inboard direction may point to a direction toward a center of a vehicle. The outboard direction may point to a direction away from the center of the vehicle. Herein, a disengagement system is described for moving the axle shaft 210 inboard or outboard to engage the first mode 200 of the second mode 250.

In the second mode 250, which is a drive mode and the hub rotates with the axle shaft 210, hub bolts 232 are engaged (e.g., threaded) and a clip 222 is disengaged with a second groove 224 of the side gear 220. Herein, the second groove 224 is referred to as a side gear groove 224. The clip 222 is compressed against an interior of the side gear 220 and expands within a first groove 221 of the axles shaft 210. A flange 212 of the axle shaft 210 is pressed against the wheel hub 230 in the drive mode via the bolts 232.

In one example, the side gear 220 is arranged in a differential case, wherein the differential case is arranged inboard of the axle shaft 210 and an opposite axle shaft that optionally couples to another wheel on a shared axis with the axle shaft 210. Other embodiments of the disengagement system shown herein may include where the clip 222 is arranged in the side gear 220, the differential case, the wheel hub 230, and/or the axle guide 214. The axle guide 214 may be interchangeably referred to as an inboard seal and is configured to accommodate the movement of the axle shaft 210 between the first mode and the second mode. The inboard seal may be a sleeve or other element.

In the first mode (e.g., a tow mode), the hub bolts 232 are disengaged. In one example, the hub bolts 232 may be completely removed. Additionally or alternatively, the hub bolts 232 may be disengaged such that the hub bolts 232 are no longer threaded with the hub 230. In one example, the hub bolts 232 may still be threaded to the flange 212. In this way, the hub bolts 232 may be kept in place for reengagement with the hub 230.

Disengagement of the hub bolts 232 may include one or more elements for resisting tampering and/or undesired disengagement of the hub bolts. In one example, the hub bolts 232 may not be disengaged unless a button within a vehicle cabin is depressed. Additionally or alternatively, an option from a mobile device, key fob, or other electronic device may be selected to initiate disengagement of the hub bolts 232. Upon receiving the request, the hub bolts 232 may be disengaged manually via a user possessing a unique tool (e.g., a unique key socket shaped to match a head of the hub bolts). Additionally or alternatively, an electronic actuator may begin to disengage the hub bolts 232 in response to the option being selected. In some examples, additionally or alternatively, the hub bolts 232 may only be disengaged when certain gears of the vehicle are in operation. For example, the hub bolts 232 may only be disengaged when the vehicle is in a park gear. Additionally or alternatively, the hub bolts 232 may only be disengaged when the vehicle is stopped.

In the first mode 200, the clip 222 is engaged with the side gear groove 224 and the axle shaft groove 221. As such, the axle shaft groove 221 and the side gear groove 224 are aligned due to the outboard movement of the axle shaft 210 toward a wheel. The axle shaft 210 may be moved outboard via the user and/or via an electronic actuator configured to move the axle shaft 210. The clip 222 may resist (e.g., stop) movement of the axle shaft 210 once the clip expands into the side gear groove 224. When the axle shaft 210 is moved outboard, the flange 212 is spaced away from the wheel hub 230, which may allow the wheel to spin independently of the motor, differential, and gear system.

In one example, one or more components of the disengagement system may include a chamfer to reduce a force demanded to push the axle shaft 210 inboard from the outboard position of the first mode 200. In the example of FIGS. 2A and 2B, the side gear groove 224 includes a chamfer 225 on an inboard side of the side gear groove. The chamfer 225 may allow the axle shaft 210 be pushed in with less force relative to the grooves only including a square cross-sectional shape. Additionally or alternatively, the clip 222 may include a chamfer on its inboard side.

Thus, in the first embodiment, the first groove 221 is arranged in the axle shaft 210 and the second groove 224 is arranged in the side gear 220. When the bolts 232 are installed, the clip 222 is compressed and fills only the first groove 221 inboard of the second groove 224. Once the bolts 232 are removed, the axle shaft 210 may be pulled outboard until the clip 222 snaps into the second groove 224 and engaged with each of the first groove 221 and the second groove 224, thereby allowing the wheel to rotate independently of the drivetrain during a tow mode while retaining lubricant in the axle system.

Turning now to FIGS. 3A and 3B, they show a second embodiment of an axle shaft 310 and a wheel in a first mode 300 and a second mode 350, respectively. FIGS. 3A and 3B are described in tandem herein. The axle shaft 310 is coupled to a side gear 320 and a wheel hub 330. The side gear 320 may be more central (e.g., inboard) than the wheel hub 330. In one example, the first mode 300 is a tow mode and the second mode 350 is a drive mode. In one example, the axle shaft 310, the side gear 320, and the wheel hub 330 may be used similarly to the axle shaft 210, the side gear 220, and the wheel hub 230 of FIGS. 2A and 2B.

In the second mode (e.g., a drive mode), hub bolts 332 are engaged and threaded into the hub 330. A clip 322 is engaged with a first side gear groove 326 of the side gear 320. More specifically, the clip 322, is engaged with the first side gear groove 326 and an axle groove 324. The flange 312 is engaged and pressed against the wheel hub 330, resulting in the wheel spinning dependent of the drivetrain.

In the first mode (e.g., tow mode), the hub bolts are disengaged and no longer threaded to the hub 330. The clip 322 is engaged with a second side gear groove 328 of the side gear 320. The second groove 328 is more outboard than the first groove 326 of the side gear 320. The axle shaft 310 may move in the outboard direction due to the bolts being removed, with results in a gap being arranged between the flange 312 and the wheel hub 330. As such, the wheel may rotate independently of the drivetrain during the tow mode while the grooves and clip system retain lubricant in the axle system.

In one example, one or more of the first side gear groove 326, the second side gear groove 328, and the clip 322 may include a chamfer to decrease a force needed to move the axle shaft 310. In one example, the first side gear groove 326 may include a chamfer on the outboard side and the second side gear groove 328 may include a chamfer on its inboard side. As such, the chamfer of the first side gear groove 326 may facilitate smoother movement of the axle shaft 310 in the outboard direction and the chamfer of the second side gear groove 328 may facilitate smoother movement of the axle shaft 310 in the inboard direction. Additionally or alternatively, only one of the first side gear groove 326 and the second side gear groove 328 may include the chamfer.

Turning now to FIGS. 4A and 4B, they show a third embodiment of an axle shaft 410 and a wheel in a first mode 400 (e.g., a tow mode) and a second mode 450 (e.g., a drive mode), respectively. FIGS. 4A and 4B are described in tandem herein. The axle shaft 410 is coupled to a side gear 420 and a wheel hub 430. The side gear 420 may be more central (e.g., inboard) than the wheel hub 430. In one example, the first mode 400 is a tow mode and the second mode 450 is a drive mode. The axle shaft, side gear 420, and wheel hub 430 may be used similarly to the axle shafts, side gears, and wheel hubs of FIGS. 2A-3B.

In the drive mode, hub bolts 432 are engaged and threaded into the hub 430. A clip 422 is engaged with a side gear groove 426 of the side gear 420. More specifically, the clip 422, is engaged with an inboard end of the side gear groove 426 and an axle groove 424 of the axle shaft 410. The first groove 426 is longer than the second groove 424. In one example, the clip 422 is engaged with an inboard edge of the side gear groove 426. The flange 412 is engaged and pressed against the wheel hub 430, resulting in the wheel spinning dependent of the drivetrain.

In the tow mode, the hub bolts 432 are disengaged and no longer threaded with the wheel hub 430. The clip 422 is engaged with an outboard edge of the side gear groove 426. In one example, the outboard edge of the side gear groove 426 is an opposite extreme end of the side gear groove 426 relative to the inboard edge. The axle shaft 410 may move in the outboard direction due to the bolts being removed, with results in a gap being arranged between the flange 412 and the wheel hub 430. A spring 414 or other similar element may apply pressure and push the flange 412 away from the wheel hub 430. As such, the wheel may rotate independently of the drivetrain during the tow mode while the grooves and clip system retain lubricant in the axle system.

Turning now to FIG. 5, it shows a method 500 for operating the disconnect system. Instructions for carrying out method 500 may be executed by a controller based on instructions stored on a memory of the controller and in conjunction with signals received from sensors of the engine system. The controller may employ engine actuators of the engine system to adjust engine operation, according to the method described below. As used herein, the term “approximately” is construed to mean plus or minus five percent of the range unless otherwise specified.

The method 500 begins at 502, which includes determining operating conditions. Operating conditions may include but are not limited to a gear selected, a mode selected, a battery state of charge (SOC), and the like.

At 504, the method 500 may include determining if a first mode is initiated. The first mode is a tow mode. If the tow mode is initiated, then a park gear may be selected and/or the battery (SOC) may be less than a lower threshold SOC. The tow mode may be selected by a vehicle operator through via depressing a button in a vehicle cabin interior, a mobile device, or the like. Additionally or alternatively, a tow cable hookup may be coupled to the vehicle and the first mode may be initiated.

If the first mode is not initiated, then at 506, the method 500 may include indicating the second mode is initiated, where the bolts are engaged. In one example, the second mode is a drive mode. The bolts may be engaged with a vehicle operator actuating the bolts via a specialized tool (e.g., a wrench). Additionally or alternatively, the bolts may be actuated via a vehicle actuator configured to adjust the position of the bolts based on the selected mode. As such, the clip may be disengaged with a groove of the side gear or engaged with a different section of the groove of the side gear.

At 508, the method 500 may include moving the axle and flange inboard. As such, the flange may be pressed against and coupled to the wheel hub via the plurality of wheel hub fasteners. In one example, the plurality of wheel hub fasteners may be tightened via an electronic actuator of the vehicle. Additionally or alternatively, the plurality of wheel hub fasteners may be manually tightened via the user.

At 510, the method 500 may include rotating the wheels dependent of the drivetrain.

Returning to 504, if the first mode is initiated, then at 512, the method 500 may include removing the fasteners. The fasteners may be removed by a user or via an actuator of the vehicle. For example, the actuator may turn the plurality of fasteners and unthread them from a wheel hub. The fasteners may remain threaded with the flange of the axle such that the fasteners are maintained in place. By doing this, a likelihood of losing the fasteners is reduced.

At 514, the method 500 may include moving the axle and flange outboard. As such, the clip may be engaged with a groove of the side gear or engaged with a different section of the groove of the side gear. The axle and flange may be moved via an axle actuator, such as a spring or other actuator. In some examples, the axle actuator may be electrically controlled. Additionally or alternatively, the axle shaft may be manually actuated via the user.

At 516, the method 500 may include rotating the wheel independently of the drivetrain. As such, the vehicle may be towed without degrading the drivetrain.

The disclosure provides support for a system including a disconnect device of an axle system, the disconnect device comprising a clip configured to engage with an axle groove of an axle and a side gear groove of a side gear. A first example of the system further includes a flange integrally arranged with the axle, wherein the flange is optionally physically coupled to a wheel hub via a plurality of wheel hub fasteners. A second example of the system, optionally including the first example, further includes where the side gear groove is a first side gear groove, further comprising a second side gear groove outboard of the first side gear groove. A third example of the system, optionally including the one or more of the previous examples, further includes where the side gear groove is larger than the axle groove. A fourth example of the system, optionally including the one or more of the previous examples, further includes where the side gear groove comprises a chamfer at an inboard edge. A fifth example of the system, optionally including the one or more of the previous examples, further includes where the side gear groove is outboard relative to the axle groove. A sixth example of the system, optionally including the one or more of the previous examples, further includes where the clip is spaced away from the side gear groove and arranged in only the axle groove when the axle is in a first position. A seventh example of the system, optionally including the one or more of the previous examples, further includes where the clip is arranged in and engaged with each of the axle groove and the side gear groove when the axle is in a second position.

The disclosure provides support for an axle system of a vehicle including a disconnect system comprising a clip arranged in an axle groove of an axle of the axle system, wherein the clip engages with a side gear groove of a side gear in a drive condition. A first example of the axle system further includes where the side gear groove is a first side gear groove, and wherein the clip engages with a second side gear groove in a tow condition. A second example of the axle system, optionally including the first example, further includes where the axle moves outboard in the tow condition relative to the drive condition. A third example of the axle system, optionally including the one or more of the previous examples, further includes where the second side gear groove is outboard relative to the first side gear groove. A fourth example of the axle system, optionally including the one or more of the previous examples, further includes where the clip engages with an inboard edge of the side gear groove in the drive condition, and wherein the clip engages with an outboard edge of the side gear groove in a tow condition. A fifth example of the axle system, optionally including the one or more of the previous examples, further includes where the vehicle includes an all-wheel drive system. A sixth example of the axle system, optionally including the one or more of the previous examples, further includes where the disconnect system is arranged between each wheel and differential of the vehicle.

The disclosure provides additional support for a method for a disconnect system of a vehicle including moving an axle inboard toward a differential in response to a drive mode being selected and engaging a clip with an axle groove of the axle and a first portion of a side gear and moving an axle outboard away from the differential in response to a tow mode being selected and engaged the clip with the axle groove of the axle and a second portion of the side gear. A first example moving the axle inboard further comprises tightening a plurality of wheel hub fasteners through a flange and into a wheel hub. A second example of the method further includes where moving the axle outboard further comprises loosening a plurality of wheel hub fasteners from a wheel hub. A third example of the method, optionally including one or more of the previous examples, further includes where the first portion of the side gear includes a first side gear groove and the second portion of the side gear includes a second side gear groove outboard relative to the first side gear groove. A fourth example of the method, optionally including one or more of the previous examples, further includes where only the second portion of the side gear includes a side gear groove.

Note that the example control and estimation routines included herein can be used with various vehicle system configurations. The control methods and routines disclosed herein may be stored as executable instructions in non-transitory memory and may be carried out by the control system including the controller in combination with the various sensors, actuators, and other hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the control system, where the described actions are carried out by executing the instructions in a system including the various hardware components in combination with the electronic controller.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a disconnect device of an axle system, the disconnect device comprising a clip configured to engage with an axle groove of an axle and a side gear groove of a side gear.

2. The system of claim 1, further comprising a flange integrally arranged with the axle, wherein the flange is optionally physically coupled to a wheel hub via a plurality of wheel hub fasteners.

3. The system of claim 1, wherein the side gear groove is a first side gear groove, further comprising a second side gear groove outboard of the first side gear groove.

4. The system of claim 1, wherein the side gear groove is larger than the axle groove.

5. The system of claim 1, wherein the side gear groove comprises a chamfer at an inboard edge.

6. The system of claim 1, wherein the side gear groove is outboard relative to the axle groove.

7. The system of claim 1, wherein the clip is spaced away from the side gear groove and arranged in only the axle groove when the axle is in a first position.

8. The system of claim 2, wherein the clip is arranged in and engaged with each of the axle groove and the side gear groove when the axle is in a second position.

9. An axle system of a vehicle, comprising:
a disconnect system comprising a clip arranged in an axle groove of an axle of the axle system, wherein the clip engages with a side gear groove of a side gear in a drive condition.

10. The axle system of claim 9, wherein the side gear groove is a first side gear groove, and wherein the clip engages with a second side gear groove in a tow condition.

11. The axle system of claim 10, wherein the axle moves outboard in the tow condition relative to the drive condition.

12. The axle system of claim 10, wherein the second side gear groove is outboard relative to the first side gear groove.

13. The axle system of claim 9, wherein the clip engages with an inboard edge of the side gear groove in the drive condition, and wherein the clip engages with an outboard edge of the side gear groove in a tow condition.

14. The axle system of claim 9, wherein the vehicle includes an all-wheel drive system.

15. The axle system of claim 9, wherein the disconnect system is arranged between each wheel and differential of the vehicle.

16. A method for a disconnect system of a vehicle, comprising:
moving an axle inboard toward a differential in response to a drive mode being selected and engaging a clip with an axle groove of the axle and a first portion of a side gear; and
moving an axle outboard away from the differential in response to a tow mode being selected and engaged the clip with the axle groove of the axle and a second portion of the side gear.

17. The method for the disconnect system of claim 16, wherein moving the axle inboard further comprises tightening a plurality of wheel hub fasteners through a flange and into a wheel hub.

18. The method for the disconnect system of claim 16, wherein moving the axle outboard further comprises loosening a plurality of wheel hub fasteners from a wheel hub.

19. The method for the disconnect system of claim 16, wherein the first portion of the side gear includes a first side gear groove and the second portion of the side gear includes a second side gear groove outboard relative to the first side gear groove.

20. The method for the disconnect system of claim 16, wherein only the second portion of the side gear includes a side gear groove.
